(19) United States
(12) Patent Application Publication
(10) Pub. No.: US 2012/0178527 A1
(43) Pub. Date: Jul. 12, 2012

(54) RECOGNITION GAME AND METHODS THEREOF

(76) Inventors: Brian Kaskie, Las Vegas, NV (US); Alain Nguyen, Las Vegas, NV (US)

(21) Appl. No.: 13/344,685

(22) Filed: Jan. 6, 2012

Related U.S. Application Data
(60) Provisional application No. 61/430,644, filed on Jan. 7, 2011.

(51) Int. Cl. A63F 13/00

(52) U.S. Cl. 463/31

(57) ABSTRACT

The present disclosure relates to a media recognition game. In an illustrative embodiment, the game is provided on a smartphone application. The application can be provided on a graphical user interface. The smartphone can be connected to, but is not required, a network interface for communicating with an online service such as the Zune Marketplace®, Rhapsody® or iTunes®. In operation, the application can retrieve media from the online service or local data storage. In turn, a portion of the media can be played to the user. The user can then provide, to the best of their ability, an identifier for the media. The application can determine whether the user was correct and display a message dependent on whether the user's identification was right.

### REFERENCE TO RELATED APPLICATIONS

This disclosure claims priority to U.S. Provisional Application Ser. No. 61/430,644 titled RECOGNITION GAME AND METHODS THEREOF to Brian Kaskie and Alain Nguyen that was filed on Jan. 7, 2011.

### TECHNICAL FIELD

This disclosure generally relates to entertainment, and more particularly, to a question-and-answer format game having a music theme implemented on a computing device.

### BACKGROUND

Premiering in the 1950s, Name That Tune!® was a television game show that put two contestants against each other to test their knowledge of songs. In the game, a short segment of a musical tune or song was played and a game player was asked to identify the name of the tune and/or the recording artist thereof. The show was created and produced by Harry Salter and his wife Roberta. Name That Tune!® ran from 1953 to 1959 on NBC and CBS in prime time. The first hosts were Red Benson and later Bill Cullen, but George DeWitt became most identified with the show. However, the best-remembered syndicated version aired once a week from 1974 to 1981 with host Tom Kennedy.

Name That Tune!® as well as other question-and-answer format games were provided to entertain television viewers. With the advent of MP3 players and similar computing devices, the game can again be enjoyed albeit on a different platform. Using online digital media stores, a system and method for recreating the game is provided herein and can be played against a computer opponent, themselves or others. These features as well as other related attributes will be described in the present disclosure.

### SUMMARY

This summary is provided to introduce a selection of concepts in a simplified form that are further described below in the DESCRIPTION OF THE DISCLOSURE. This summary is not intended to identify key features of the claimed subject matter, nor is it intended to be used as an aid in determining the scope of the claimed subject matter.

In accordance with one aspect of the present disclosure, a gaming device is provided. The device can include a network interface connected to an online service and at least one processor. In addition, the device can include a memory operatively coupled to the processor, the memory storing program instructions that when executed by the processor, causes the processor to perform processes. The processes can include receiving media from the online service through the network interface, capturing a portion of the media, providing the portion to a user, receive input from the user identifying the media, and displaying a message to the user dependent on whether the user input identifying the media is correct.

In accordance with another aspect of the present disclosure, a method is provided. The method can include establishing a connection between two or more players, retrieving media (i.e. song, video, pictures) from a digital media store and providing the two or more players at least a portion of the media. In addition, the method can include receiving a response from the two or more players identifying the media. The method can also include identifying a player from the two or more players with a first correct response and displaying information about the player to the two or more players.

In accordance with yet another aspect of the present disclosure, a recognition game is provided. The game can include an input source, a terminal display, a data repository for storing media and a program executed to retrieve the media from the data repository and provide the media to the terminal display. The program can further be executed to receive user input to identify the media from the input source and provide a response dependent on whether the user input correctly identifies the media.

### BRIEF DESCRIPTION OF DRAWINGS

The novel features believed to be characteristic of the disclosure are set forth in the appended claims. In the descriptions that follow, like parts are marked throughout the specification and drawings with the same numerals, respectively. The drawing figures are not necessarily drawn to scale and certain figures may be shown in exaggerated or generalized form in the interest of clarity and conciseness. The disclosure itself, however, as well as a preferred mode of use, further objectives and advantages thereof, will be best understood by reference to the following detailed description of illustrative embodiments when read in conjunction with the accompanying drawings, wherein:

FIG. 1 is a general flow diagram that shows illustrative features for a question-and-answer format game in accordance with one or more aspects of the present disclosure;

FIG. 2 provides typical mobile platforms for operating the game in accordance with one or more aspects of the present disclosure;

FIG. 3 illustrates PC platforms for operating the game in accordance with one or more aspects of the present disclosure;

FIG. 4 depicts exemplary processes for single-player mode in accordance with one or more aspects of the present disclosure;

FIG. 5 depicts exemplary processes for multi-player mode in accordance with one or more aspects of the present disclosure; and

FIG. 6 shows a flow chart depicting exemplary processes for playing the game in accordance with one or more aspects of the present disclosure.

### DESCRIPTION OF THE DISCLOSURE

The description set forth below in connection with the appended drawings is intended as a description of presently preferred embodiments of the disclosure and is not intended to represent the only forms in which the present disclosure may be constructed and/or utilized. The description sets forth the functions and the sequence of steps for constructing and operating the disclosure in connection with the illustrated embodiments. It is to be understood, however, that the same or equivalent functions and sequences may be accomplished by different embodiments that are also intended to be encompassed within the spirit and scope of this disclosure.

### System Overview

Generally described, the present disclosure relates to a game. In an illustrative embodiment, the game is provided on a smartphone application. The smartphone can download the application to play the media from the smartphone owner's device. In addition, the smartphone can be connected to a network interface for communicating with an online service such as the Google Music, Rhapsody® or iTunes®. In operation, the application can retrieve media from the online service. In turn, a portion of the media can be played to the user. In one embodiment, the media can be altered, for example, providing just lyrics or just music. The user can then provide, to the best of their ability, an identifier for the media. The application can determine whether the user's identifier is correct and display a proper message thereafter.

Numerous advantages can be provided that go beyond the television show Name That Tune!®. The game can be played among two or more persons or against criteria set up a player. Single player mode as well as playing against a computer opponent can also be provided and are within the scope of the present disclosure. The game can create a challenging and rewarding experience through memorization of a user's music collection. In addition, music pulled from the online services can spark a user's interest to purchase that song. Other advantages will become apparent from the discussion provided below.

While described above as primarily a music game, other forms of media can also be used, for example, clips from movies, sitcom tunes, pictures of celebrities or superheroes, etc. Jingles or other slogans can also be used within the context of the present disclosure. Video can be used as well. The application described in this disclosure can also be used with pictures. These images can be manipulated into numerous types of games, which will be described below. Genres of music and movies can also be used. As will be shown below, the phone application can be provided in a variety of forms. The application can be implemented as a standalone application on a smartphone or other wireless device. The application can run on top of a social media site such as Facebook®, Myspace®, etc. The application can also be run on top of a personal computer or gaming system. Many additional features and elements of the present disclosure will become apparent to those of ordinary skill in the art as provided for in the following description.

### Hardware Environment

Exemplary hardware and software for implementing the game on a smartphone will be described below. The game can be run on a smartphone having a processor for implementing logic, a memory, a display and a keypad. The display of the smartphone can be a liquid crystal display (LCD), or any other type of display commonly used in mobile devices. The display can be touch-sensitive, and can act as an input device. The keypad can be a push button numeric dialing pad (such as on a typical telephone), a multi-key keyboard (such as a conventional keyboard) or any other device for inputting textual data. In some smartphones, the keypad can be shown on the display allowing the touch-sensitive display to act as the keypad.

The memory generally includes both volatile memory (e.g., RAM) and non-volatile memory (e.g., ROM, Flash Memory, or the like). The non-volatile portion of the memory can be used to store persistent information which should not be lost when the smartphone is powered down. The smartphone can include an operating system (OS), such as Windows CE or Windows Mobile available from Microsoft Corporation, Redmond, Wash., or other OS. The OS can reside in the memory and be executed on the processor.

The memory can also include one or more device managers for interacting with one or more I/O devices. The game can be installed within the memory. In one embodiment, the game can be executed at a remote site which is commonly used in client/server relationships. The memory can also include a collection of one or more APIs for facilitating wireless communication between the smartphone and one or more remote I/O devices. The APIs can be invoked by the applications to recognize and control the one or more remote I/O devices. In this manner, the smartphone is able to take advantage of services or functionalities of the one or more remote I/O devices.

The smartphone can also include a power supply, which can be implemented as one or more batteries, fuel cells, or other sources of electrical power. The power supply might further include an external power source, such as an AC adapter or a powered docking cradle that supplements or recharges the batteries. The smartphone can also include one or more audio, visual, and/or vibratory mechanisms. Typically, devices that have better audio would be well suited for the present disclosure.

The smartphone, in the present disclosure, can be connected to a music store provided through the Internet or other network. Known to those skilled in the relevant art, the music store can provide audio and video files. The files can be streamed over partially or fully without actually owning the source file. Examples of music stores include the Zune Marketplace®, iTunes®, Rhapsody®, and Yahoo Music®, etc. In one embodiment, the media can be provided by local storage devices on the smartphone. The smartphone can use both the online store along with the local storage to retrieve media.

Other types of media can be received such as videos, images, etc. Some of the online services described above can provide these types of media. In one embodiment, image providers such as Flickr® can be used. Those skilled in the relevant art will appreciate that the term media can refer to music as well as other types of data that can be transmitted to the application. Multiple sources can be used to retrieve media.

While a smartphone was primarily described, other electronic devices can be used in operation with the game application. For example, a desktop or laptop can be used to operate the game application, which will be described below. A separate gaming machine can be used and its primary function can be to operate the game application. Tablets can be used. Numerous types of devices can be used including handheld devices and devices operating remotely, for example, over the Internet. These devices can use similar components to those described above for the smartphone.

### Game Application

The recognition game can be implemented within an application. The application itself can be run on many platforms that will become apparent from the disclosure provided below. The application can be executed over the Internet and online through systems known to those skilled in the relevant art. The online version can allow players to compete against one another. Data can be streamed into each of the devices in a multi-player format. The application can also be downloaded onto a mobile platform such as a smartphone or the like.

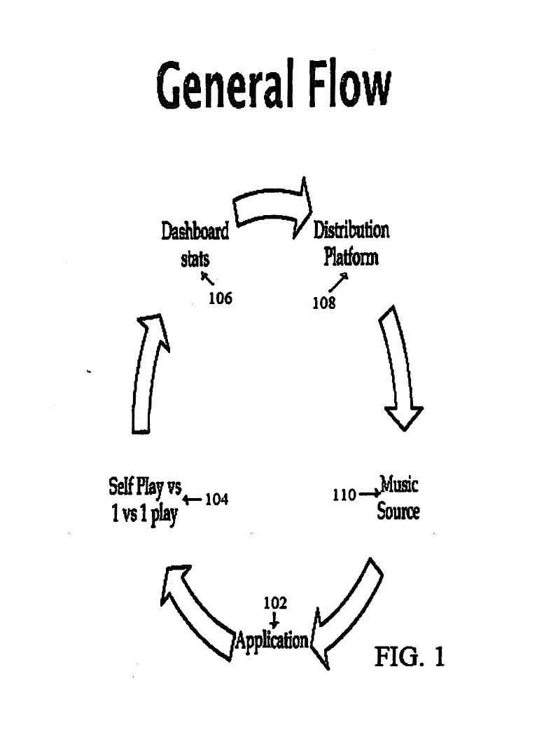

Turning now to FIG. 1, a general flow diagram that shows illustrative features for a question-and-answer format game in accordance with one or more aspects of the present disclosure is provided. The flow diagram's circular nature represents that the game can be continuously played. The diagram should not be construed as the only embodiment as fewer, more or other features can be implemented therein. At block 102, the game application can be uploaded from memory and executed by a smartphone or other device.

At block 104, the user can select whether they want to play against others or themselves. In self play, the game can allow a user to test their knowledge of media. In one embodiment, timers could be used within the program to provide added pressure to the user to come up with a correct identifier for the media. In the multi-player mode, the user can be provided the media and compete against others to correctly identify it. A combination of accuracy and time can be used to determine a winner One player, such as the challenger, can choose the genre of music being used, for example, rock. Other criteria can be selected by the players.

At block 106, dashboard statistics can be provided on the game application. When the dashboard is activated, in one embodiment, the user's surrounding applications can be dimmed including the OS. The statistics for each player can then be provided. At block 108, the game application can determine the distribution platform that the user has. Depending on the platform, different features can be applied through the game. These platforms can generally be separated into entertainment platforms, PC platforms, mobile platforms and iPads®.

At block 110, the game application can interact with the music sources to retrieve the music and provide it to the user. In one embodiment, criteria can be defined to retrieve music. One of the players, including the challengers or an entirely separate individual from the game, can define the criteria. The criteria can be then provided to the online sources. The criteria can include at least one of era, genre, album and artist. Other criteria can be provided to the online sources. Specific sources can also be selected such that the media can be received from that source. After completion of the game, the features can begin once again at block 102. Known to those skilled in the relevant art, numerous other features can be provided within FIG. 1 and are not limited to those shown. In one embodiment, the application can be set up to work with specific artists.

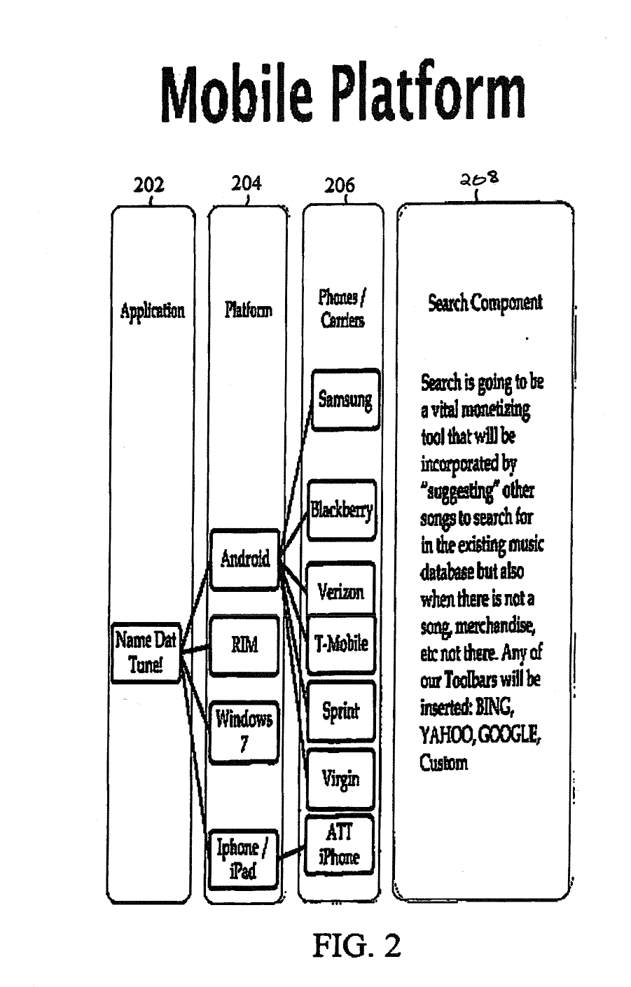

Referring to FIG. 2, typical mobile platforms for operating the game in accordance with one or more aspects of the present disclosure are provided. The mobile platform can execute the game application 202. The game application 202 can detect which platform 204 it will be operating on. The platforms 204 can include Android®, RIM®, Windows 7® and the iOS® on the iPhone®/iPad®, to name a few. Each platform 204 can be associated with phones/carriers 206. For example, the Android® platform 204 can have a phone/carrier 206 of Samsung®, Blackberry®, Verizon®, T-Mobile®, Sprint®, or Virgin®. The iPhone®/iPad® platform 204 can have an ATT® iPhone® phone/carrier 206. A search component 208 can be provided. The component 208 can be used to suggest other songs to search for in an existing music database. This component 208 can look for media in different services.

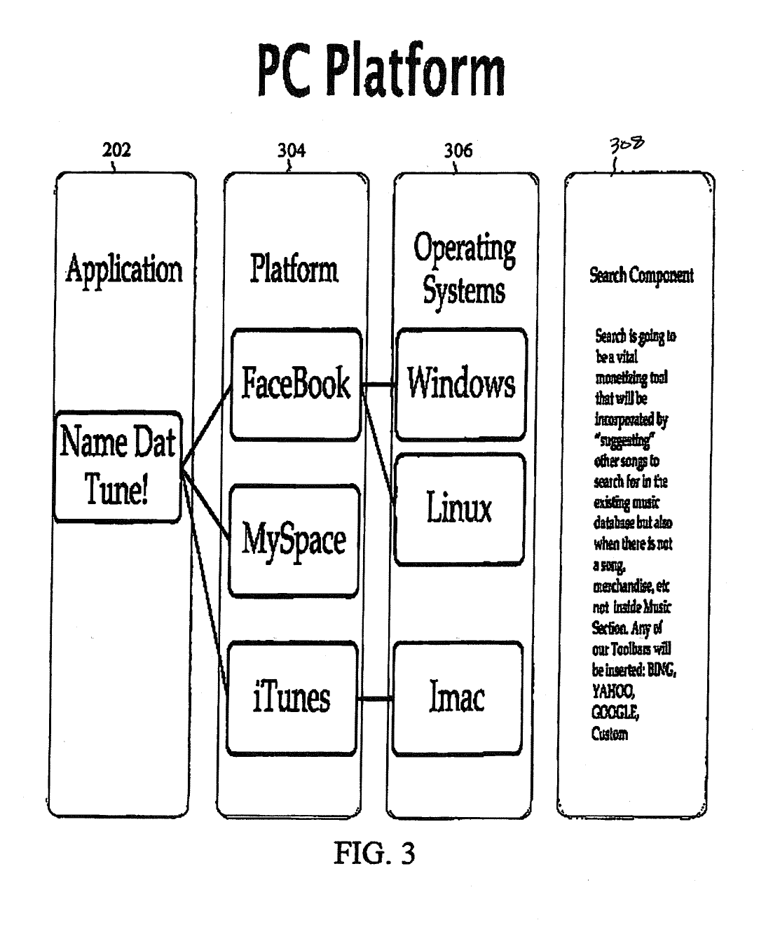

FIG. 3 illustrates PC platforms for operating the game 202 in accordance with one or more aspects of the present disclosure. The game application 202 can operate with many platforms 304 including Facebook®, MySpace® and iTunes®. Other social networking sites and platforms can be used by the application 202. In turn, the platforms 304 can work with operating systems 306 such as Windows®, Linux® and iMac®.

In each of the platforms 204 and 304, a search component 308 can be incorporated. The search components 308 can be a toolbar that inserts Bing®, Yahoo! ® or Google®. The search component 308 can be used to suggest other songs to search for in the existing music database. This can create a revenue generation stream.

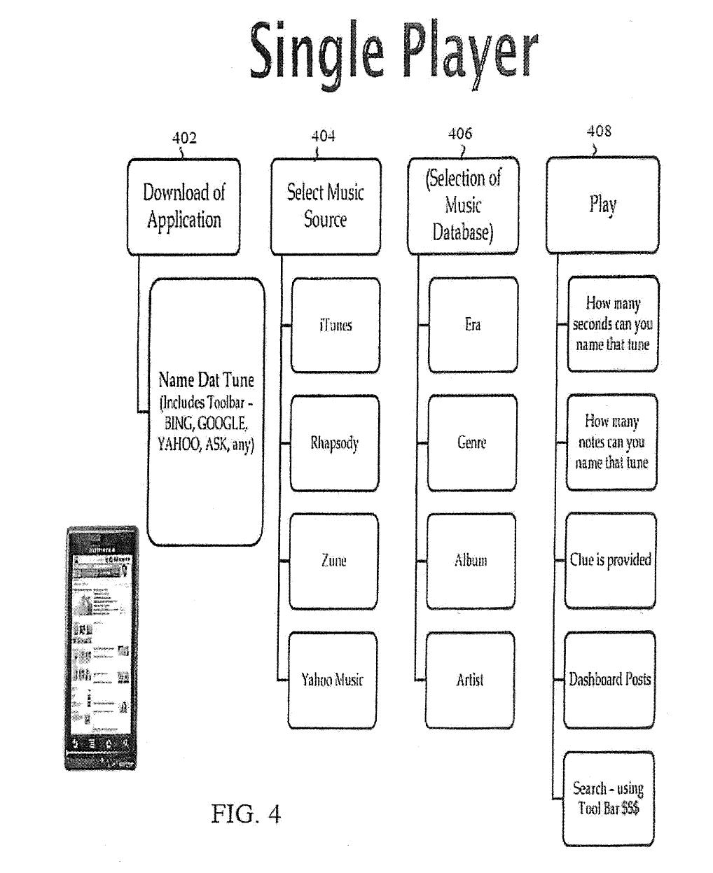

Turning now to FIG. 4, exemplary processes for a single-player mode in accordance with one or more aspects of the present disclosure is provided. Those skilled in the relevant art will appreciate that fewer, more or different processes can be used. At block 402, the single player mode can begin with downloading the game application 202. In one embodiment, the application 202 can be preinstalled. The application 202 can also reside on an application server and then provided through a number of online services.

At block 404, the player can select the music source that the application 202 can choose from. This can occur randomly or through player provided input. A challenger or unrelated party to the game can also choose the music source or song itself. The music source can include iTunes®, Rhapsody®, Zune® and Yahoo Music®, to name a few. In one embodiment, the music can be retrieved from a local data storage. At block 406, the player can provide criteria identifying selections within the music database. For example, the music can be classified by era, genre, album and artists.

At block 408, different methods for playing the game can be implemented by the user. In one embodiment, the player can enter the number of seconds by selecting Easy, Medium or Hard levels that they think they can name the song/media in. A section of the retrieved music can then be taken and provided to the user. The player can then provide an identifier associated with the song/media. The identifier can include the song title, album title, artist, etc. The player can win if they can name it within the seconds specified. In another embodiment, the player can compete with themselves as a function of time, which can be kept track of.

The game can also provide clues on the media selected. For example, the era, genre, album or artist can be provided to give the player hints about the media selected. In addition, dashboard posts can be provided as well as a search bar. Lyrics or music only selections can be implemented by the application 202.

Other types of media can be used and variations of the game described above can be implemented. For example, a grainy image of a super hero can be displayed on a smartphone. The player or players would be asked by the game application 202 to discern which superhero is within the image. Images, clips of videos, etc. can all be used. Portions of the media can be presented to the player or players and a correct response can be determined by the application 202.

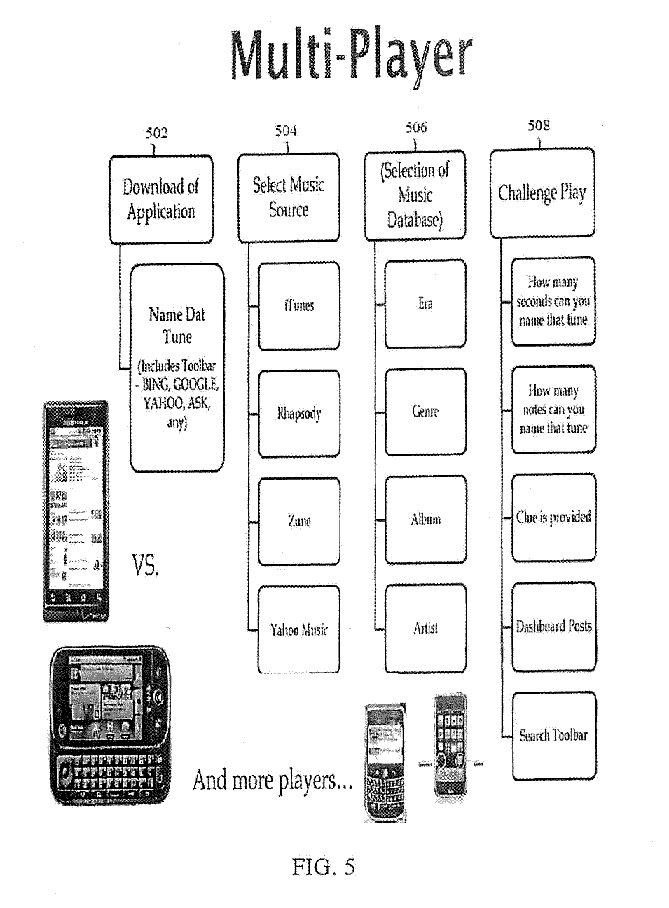

FIG. 5 depicts exemplary processes for a multi-player mode in accordance with one or more aspects of the present disclosure. At block 502, the multi-player mode can begin with the downloading of the game application 202. In one embodiment, the application 202 can be preinstalled. The application 202 can also reside on an application server and then provided through a number of online services. At block 504, the player can select the music source that the application 202 can choose from. If other types of media are used, the correct source can be contacted. This can be provided as a consensus among the players. Alternatively, the game application 202 can allow each of the players to take a turn to select the type of music. The same sources can be used as before. In one embodiment, a player can act like a dealer and determine which music is played. The other players would then have to decide the correct identity of the music.

The player can select the music type from the database at block 506. For example, a player can select music based on an era, genre, album or artist. At block 508, game play can be implemented. In one embodiment, the players can play against each other to see who can determine the correct identity of the song in the least amount of time. In another embodiment, the number of beats can be used as a factor between the players to determine the winner. The players can compete with each other trying to specify the number of seconds by selecting Easy, Medium, Hard levels that they can name the song/media in. This can be done on the same device or different devices.

The game application 202 can provide clues on the media selected during game play. For example, the era, genre, album or artist can be provided to give the player a hint In addition, dashboard posts can be provided. A search bar can be included as well. Those skilled in the relevant art will appreciate that the different forms of media can be used and were presented in the disclosure. The game application 202 can provide an advertising platform. For example, record labels can entice users to purchase a song or other media that is part of the game.

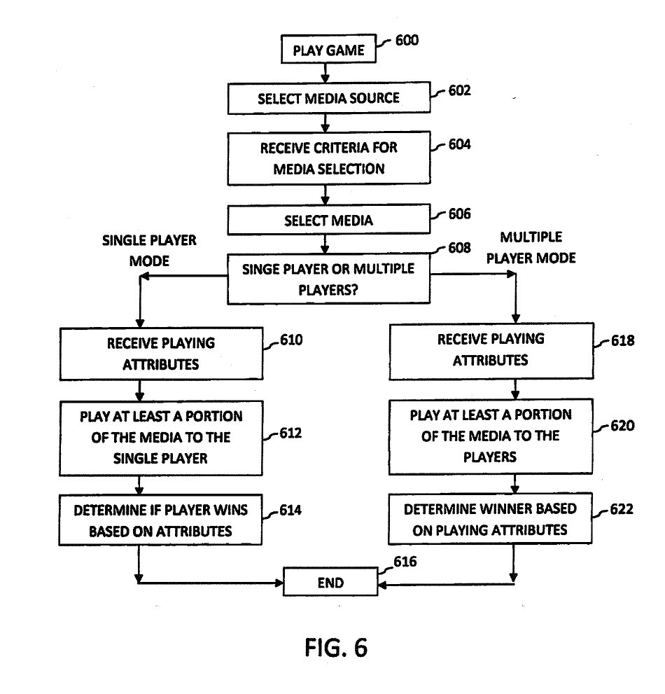

FIG. 6 shows a flow chart depicting exemplary processes for playing the game in accordance with one or more aspects of the present disclosure. Those skilled in the relevant art will appreciate that fewer, more or different processes can be used. This can be implemented on a smartphone or other platform described above. The processes for playing the game can begin at block 600.

At block 602, a media source can be selected. In one embodiment, this can be performed by a single player. The selected media source can depend on which type of media is being used, for example, images, videos, music, etc. When multiple players are playing, the source can be selected by a single player, randomly or from all the players. An entirely separate party can also choose the source. The game can receive criteria for the media selection at block 604. This criteria can include era, genre, album and artist to name a few. Other types of criteria can be used dependent on the media played with the game. For example, superheroes, fictional characters, etc. can be used as criteria for images. At block 606, the media can be selected. This media can include songs as well as other forms such as images and videos.

At decision block 608, a determination is made whether the game is to be played by a single player or multiple players. In single player mode, at block 610, the game can receive playing attributes from the player. For example, the player can specify the number of seconds that they can name the media in. At block 612, at least a portion of the media can be played to the single player. The game can then determine if the player wins at block 614. The game can determine the winner based on the attributes provided above. The game can end at block 616.

When multiple players are playing the game, at block 618, the game can receive playing attributes. These attributes can include how many seconds the media will play for. At block 620, at least a portion of the media depending on the attributes provided earlier can be played to the players. The media can be synchronized such that the media is played at the same time for each of the players. At block 622, the game can determine a winner based on the playing attributes. For example, the winner that correctly identifies the song/media in the least amount of time wins. Alternatively, the player with the least amount of time to name the tune wins. In one embodiment, the player that identifies the most song/media wins. Percentages can also be factored into the game, for example, how many songs/media were correctly or incorrectly identified. The game can end at block 616.

### Systems, Methods and Operations

In accordance with one aspect of the present disclosure, a gaming device is provided. The device can include a network interface connected to an online service, at least one processor and a memory operatively coupled to the processor, the memory storing program instructions that when executed by the processor, causes the processor to perform processes. The processes can include receiving media from the smartphone's music/media file in addition from the online service through the network interface, capturing a portion of the media, providing the portion to a user, receiving receive input from the user identifying the media and displaying a message to the user dependent on whether the user input identifying the media is correct.

In one embodiment, the memory storing program instructions when executed by the processor causes the processor to display a plurality of online services and receive a selection for the online service. In one embodiment, the plurality of online services includes at least one of Zune Marketplace®, Rhapsody® and iTunes®. In one embodiment, the memory storing program instructions when executed by the processor causes the processor to randomly select the online service.

In one embodiment, the memory storing program instructions when executed by the processor causes the processor to receive a selection for the online service from a challenger. In one embodiment, receiving the media from the online service through the network interface can include receiving criteria for selecting the media and sending the criteria to the online service for selection of the media. In one embodiment, the criteria can include at least one of era, genre, album and artist.

In one embodiment, capturing the portion of the media can include receiving playing attributes and sectioning the portion defined by the playing attributes. In one embodiment, sectioning the portion defined by the playing attributes can include capturing a number of beats defined by the playing attributes. In one embodiment, sectioning the portion defined by the playing attributes can include capturing a number of words defined by the playing attributes.

In accordance with another aspect of the present disclosure, a method for playing a recognition game through a number of devices operated by two or more players is provided. The method can include establishing a connection between the two or more players, retrieving a song from a digital media store, providing the two or more players at least a portion of the song, receiving a response from the two or more players identifying the song, identifying a player from the two or more players with a first correct response and displaying information about the player to the two or more players.

In one embodiment, establishing the connection between the two or more players can include determining a platform and carrier for the two or more players. In one embodiment, the method can include comprising displaying a search component for retrieving the song. In one embodiment, the method can include displaying statistical information.

In accordance with yet another aspect of the present disclosure, a recognition game is provided. The game can include an input source, a terminal display, a data repository for storing music and a program. The program when executed can retrieve the music from the data repository and provide the music to the terminal display. The program when further executed can receive user input to identify the music from the input source and provide a response dependent on whether the user input correctly identifies the music.

In one embodiment, the program is further executed to penalize a player for an incorrect response. In one embodiment, the penalties include deducting points. In one embodiment, the program is further executed to keep statistics for wins and losses for a plurality of players. In one embodiment, a portion of the music is provided to the terminal display. In one embodiment, the data repository is within a cloud.

The foregoing description is provided to enable any person skilled in the relevant art to practice the various embodiments described herein. Various modifications to these embodiments will be readily apparent to those skilled in the relevant art, and generic principles defined herein may be applied to other embodiments. Thus, the claims are not intended to be limited to the embodiments shown and described herein, but are to be accorded the full scope consistent with the language of the claims, wherein reference to an element in the singular is not intended to mean “one and only one” unless specifically stated, but rather “one or more.” All structural and functional equivalents to the elements of the various embodiments described throughout this disclosure that are known or later come to be known to those of ordinary skill in the relevant art are expressly incorporated herein by reference and intended to be encompassed by the claims. Moreover, nothing disclosed herein is intended to be dedicated to the public regardless of whether such disclosure is explicitly recited in the claims.

What is claimed is:

1. A gaming device comprising:
at least one processor; and
a memory operatively coupled to said processor, said memory storing program instructions that when executed by said processor, causes said processor to:
receive media;
capture a portion of said media;
provide said portion to a user;
receive input from said user identifying said media;
display a message to said user dependent on whether said user input identifying said media is correct.

2. The gaming device of claim 1, wherein said memory storing program instructions when executed by said processor causes said processor to display a plurality of online services for said media and receive a selection for said online service to provide said media.

3. The gaming device of claim 1, wherein said media is at least one of a video, picture, film and movie.

4. The gaming device of claim 1, wherein said memory storing program instructions when executed by said processor causes said processor to randomly select an online service to provide said media.

5. The gaming device of claim 1, wherein said memory storing program instructions when executed by said processor causes said processor to receive a selection for an online service to provide said media from a challenger.

6. The gaming device of claim 1, wherein receiving said media comprises connecting with an online service through a network interface, receiving criteria for selecting said media and sending said criteria to said online service for selection of said media.

7. The gaming device of claim 6, wherein said criteria comprises at least one of era, genre, album and artist.

8. The gaming device of claim 1, wherein capturing said portion of said media comprises receiving playing attributes and sectioning said portion defined by said playing attributes.

9. The gaming device of claim 8, wherein sectioning said portion defined by said playing attributes comprises capturing a number of beats defined by said playing attributes.

10. The gaming device of claim 8, wherein sectioning said portion defined by said playing attributes comprises capturing a number of words defines by said playing attributes.

11. A method for playing a recognition game through a number of devices operated by two or more players, said method comprising:
establishing a connection between said two or more players;
retrieving media from a digital media store or respective callers music database;
providing said two or more players at least a portion of said media;
receiving a response from said two or more players identifying said media;
identifying a player from said two or more players with a first correct response; and
displaying information about said player to said two or more players.

12. The method of claim 11, wherein establishing said connection between said two or more players comprises determining a platform and carrier for said two or more players.

13. The method of claim 11, comprising displaying a search component for retrieving said media.

14. The method of claim 11, comprising displaying advertising information.

15. A recognition game comprising:
an input source;
a terminal display;
a data repository for storing media; and
a program executed to retrieve said media from said data repository and provide said media to said terminal display, said program further executed to receive user input to identify said media from said input source and provide a response dependent on whether said user input correctly identifies said media.

16. The recognition game of claim 15, wherein said program is further executed to penalize a player for an incorrect response.

17. The recognition game of claim 15, wherein said program is further executed to link with a search engine.

18. The recognition game of claim 15, wherein said program is further executed to keep statistics for wins and losses for a plurality of players.

19. The recognition game of claim 15, wherein a portion of said music is provided to said terminal display.

20. The recognition game of claim 15, wherein said data repository is within a cloud.
